(19) United States
(12) Patent Application Publication
(10) Pub. No.: US 2005/0262245 A1
(43) Pub. Date: Nov. 24, 2005

(54) Scalable cluster-based architecture for streaming media

(76) Inventors: Satish Menon, Sunnyvale, CA (US); Jayakumar Muthukumarasamy, Dublin, CA (US); Innocent Azinyue, Los Altos, CA (US); Vinay Joshi, Saratoga, CA (US)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/110,101

(22) Filed: Apr. 19, 2005

Related U.S. Application Data
(60) Provisional application No. 60/563,606, filed on Apr. 19, 2004.

(51) Int. Cl. G06F 15/173

(52) U.S. Cl. 709/226

(57) ABSTRACT

A scalable, cluster-based VoD system implemented with a multi-server, multi-storage architecture to serve large scale real-time ingest and streaming requests for content assets is provided. The scalable, cluster-based VoD system implements sophisticated load balancing algorithms for distributing the load among the servers in the cluster to achieve a cost-effective and high streaming and storage capacity solution capable of serving multiple usage patterns and large scale real-time service demands. The VoD system is designed with a highly-scalable and failure-resistant architecture for streaming content assets in real-time in various network configurations.

### CROSS REFERENCE TO RELATED APPLICATIONS

This application claims priority to U.S. Provisional Application No. 60/563,606, entitled “Clustering Architecture for Scalability and Availability of Servers” and filed on Apr. 19, 2004, the entire disclosure of which is incorporated herein by reference.

The present application is related to commonly-owned U.S. patent application Ser. No. ______ (Attorney Docket No. 34316/US/3), entitled “Systems and Methods for Load Balancing Storage and Streaming Media requests in a Scalable Cluster-Based Architecture For Real-Time Streaming” and filed concurrently on Apr. 19, 2005; U.S. patent application Ser. No. 09/916,655, entitled “Improved Utilization of Bandwidth in a Computer System Serving Multiple Users” and filed on Jul. 27, 2001; U.S. patent application Ser. No. 08/948,668, entitled “System For Capability Based Multimedia Streaming over A Network” and filed on Oct. 14, 1997; U.S. patent application Ser. No. 10/090,697, entitled “Transfer File Format And System And Method For Distributing Media Content” and filed on Mar. 4, 2002; and U.S. patent application Ser. No. 10/205,476 entitled “System and Method for Highly-Scalable Real-Time and Time-Based Data Delivery Using Server Clusters” and filed on Jul. 24, 2002, each of which applications is hereby incorporated by reference.

### FIELD OF THE INVENTION

This invention relates generally to systems and methods for streaming content assets. More specifically, the invention provides a fully-scalable, cluster-based system for streaming content assets in real-time under various usage patterns and load balancing requirements.

### BACKGROUND OF THE INVENTION

Advances in computer networking have enabled the development of powerful and flexible new media distribution technologies. Consumers are no longer tied to the basic newspaper, television and radio distribution formats and their respective schedules to receive their written, audio, or video media. Media can now be streamed or delivered directly to computer desktops, laptops, personal digital assistants (“PDAs”), wireless telephones, digital music players, and other portable devices, providing virtually unlimited entertainment possibilities.

Streaming media include media that are consumed while being delivered and typically made available to consumers on demand. For example, audio-on-demand (“AoD”) services allow consumers to listen to audio broadcasts and live music concerts on various web sites or download and play audio files as desired. Such services are now a staple of the Internet and have fundamentally altered the way music is distributed and enjoyed by music lovers everywhere.

Video-on-demand (“VoD”) services, while not as popular as their audio counterpart, are becoming increasingly more common as the technical challenges associated with streaming large amounts of image, video, or other visual or visually-perceived data with limited bandwidth are resolved. Unlike audio that can be easily encoded, streamed and stored with currently-available encoding standards and storage technologies, streaming video requires a very high streaming bandwidth, typically on the order of 3-8 Mbits/sec, and places a tremendous load on the video servers and associated system resources that are used to deliver the video to the end consumer.

An exemplary diagram of a network and system configuration for delivering streaming video to consumers is shown in FIG. 1. In general, consumers access streaming video through a number of devices, such as through TV and set-top box 105 and computer 110. The consumers are connected to content distribution network 115, which may be a local or wide area network or any other network connection capable of distributing streaming media to consumers in real-time. Streaming video is delivered to consumers by means of streaming video distributor 120 with VoD system 125, which may be implemented in a number of ways described hereinbelow. VoD system 125 typically has video server and storage capabilities.

Streaming video distributor 120 may be, for example, a cable head-end that originates and communicates cable TV and cable modem services to consumers, a web site of a media broadcasting company, such as ABC, CBS, NBC, CNN, etc., or another web site capable of performing streaming video services to consumers. Streaming video may be delivered on a subscription or pay-per-view basis. Additionally, remote VoD systems 130-135 may be connected to content distribution network 115 to serve any service needs of streaming video distributor 120 that cannot be handled solely by VoD system 125. These are merely examples and are not intended to limit the type of video or imagery or means by which video or other image data may be streamed.

Deploying a VoD system for commercial use requires not only the tight management of system resources but also the ability to scale the system economically in terms of the number of consumers supported as well as the amount of video content managed by the system. Resources that must be tightly managed for streaming real-time video include I/O resources such as I/O storage and bandwidth, CPU resources, memory, and network bandwidth. The VoD system may have to support content access on a subscription basis to a large number of subscribers and manage a wide variety of content, including full-length feature movies and short-form content such as cartoons, travel videos, and video clips, among others.

Additionally, the VoD system should be able to manage content access by offering “walled garden” services where the VoD system maintains, manages, and restricts access on a subscription basis. The VoD system must also be designed to offer personalized subscription services that enable subscribers to perform a number of features, include pausing and recording live streaming video.

Furthermore, a commercial VoD system should consider common content usage patterns to ensure that system resources are managed efficiently. Such usage patterns include the so called “80/20” or “90/10” popular usage pattern, in which 80-90% of the peak content requests received by the system are for 20-10% of the content, and the uniform usage pattern, which occur when most, if not all, content gets approximately the same number of requests. Other usage patterns include the subscription-based usage patterns, in which subscribers access a wider variety of content that tends to be short-to-medium form, around 30-60 minutes long.

The VoD system must also be able to handle so called “flash floods,” which occur when a near-instantaneous flood of requests is received for one of a few pieces of content. This might occur in some Internet video streaming applications, where thousands of users request the same content in a span of a few seconds. For example, flash floods may be prevalent in news programs after catastrophic events or popular programs such as the Super Bowl or World Cup Soccer final.

As the number of subscribers to a VoD system grows, it becomes necessary to add streaming capacity. Desirably the initial VoD system is retained and the initial system architecture is scaled to serve the additional subscribers. A small video server system capable of serving a few hundred users must become part of a larger system that serves hundreds of thousands. Prior art approaches that have been taken to provide scalability in a VoD system include: (1) the deployment and use of tightly-coupled microprocessor systems delivering a large number of streams, and (2) loosely-coupled clusters that are composed of small, off-the-shelf computers, but connected using standard computer networks.

In the first approach, the video server begins service with a few processor boards and boards are added as the system grows. Such a system tends to be very costly and does not usually meet the strict cost constraints placed by commercial VoD systems. There is also the potential for failure of one board to cause total failure of the video server. Further, as the system grows, the cost of computational power decreases, and the processor boards required to update the system may be outdated by the time a system administrator is prepared to grow the video server.

In the second approach, small, off-the-shelf computers are connected through a standard fiber network and receive video requests from a load balancing component that directs the video requests to one of the servers within the system. The load balancing component may be a Layer-4 switch, a software load balancing proxy, or a software round-robin DNS, among others. Shared storage devices connected to the fiber such as fiber-channel switches, switch adapters, disks that are fiber-channel capable, etc., are additional cost components and add complexity to the scalability of the network.

While an improvement over the single-server model with multiple processor boards, this approach still does not solve the resource management problem of how to effectively balance network bandwidth and connection overhead. Because the storage devices are typically connected to the fiber through a fiber channel switch, the VoD system can only provide videos stored in the storage devices at the limited bandwidth available from the storage devices to the switch. As a result, popular videos that are accessed frequently need to be copied to memory for faster access, thereby wasting system resources and restricting the ability of the VoD system to handle very large video files or too many users.

Additionally, currently-available prior-art VoD systems are not capable of handling large scale real-time streaming and ingest requests that often occur when a large number of users with various usage patterns have access to the systems. When large scale demands are placed in those systems, they may fail entirely or cause multiple users to have their requests interrupted. Those systems may also not be able to handle usage spikes, unanticipated flash floods, or a large number of requests for the same content. In short, currently-available VoD systems do not easily scale its streaming and storage capacities without presenting load balancing or failure problems.

To address the scalability and resource-management problems of prior-art commercial VoD systems, a scalable cluster-based VoD system, method, architecture, and topology that is able to cost-effectively, timely, and easily increase the streaming and storage capacity of prior-art VoD systems was developed. Embodiments of the scalable cluster-based VoD system are described in commonly-owned U.S. patent application Ser. No. 10/205,476 entitled “System and Method for Highly-Scalable Real-Time and Time-Based Data Delivery Using Server Clusters” and filed on Jul. 24, 2002, incorporated herein by reference in its entirety. Embodiments of the scalable cluster-based VoD system are also embedded in the Video Delivery Platform (VDP) and the Video Services Platform (VSP) line of products sold by Kasenna, Inc., of Mountain View, Calif.

The scalable, cluster-based VoD system is formed by a group or cluster of servers that share physical proximity and are connected through a network, either a local area network (LAN) or a wide area network (WAN). The cluster has a single virtual address (SVA) that can be enabled via a load balancing component, such as a Layer-2, a Layer-4, or a Layer-7 switch, among others. The load balancing component receives all the content requests directed to the cluster by users or subscribers to the system and forwards the requests to one of the servers in the cluster. Alternatively, a load balancing component may be omitted in favor of using one of the servers in the cluster as central dispatcher to receive and handle or redirect content requests to servers in the cluster.

The scalable, cluster-based VoD system is also implemented to share content metadata information across all servers in the clusters. Metadata information is information about content such as content availability, server status, current load, and server type, i.e., whether ingest, streaming server, or both. Shared content metadata enables any server in the cluster to receive a content request, handle the request or forward the request to another server in the cluster with the resources and capabilities to handle the request. Shared content metadata is implemented by using a cluster software agent that runs on every server to communicate metadata information periodically. The cluster software agent also keeps track of the current load average in each server based on monitored system resources, such as CPU usage, free physical and swap memory, available network bandwidth, among others.

The cluster implementation enables the VoD system to scale near-linearly, support a multitude of content usage patterns, provide increased system availability such that a component failure will not make the complete system unavailable, use off-the-shelf components, i.e., hardware, storage, network interface cards, file systems, etc., without any modifications, and be cost-effective. Further, the cluster implementation enables content to be stored very efficiently, without having to store the same content in all servers in the system.

The scalable, cluster-based VoD system may be implemented using two different storage models: (1) a shared storage model; or (2) a direct attach storage model. In the shared storage model shown in FIG. 2, a cluster of servers is connected to a shared storage subsystem, such as a storage area network that is connected using a fiber channel interface or a network-attached storage subsystem. Storage is made available in the form of one or more shared file systems. In scalable cluster-based VoD system 200, streaming video resides on shared storage subsystem 205. Individual servers, such as servers 210-220, store metadata locally. Installing video content into VoD system 200 generally involves installing the content on shared storage subsystem 205 and distributing the metadata associated with the video to all servers in VoD system 200.

One of the advantages of the shared storage model is that video content is uniformly accessible to all servers in VoD system 200. The maximum number of playouts is usually bounded by the bandwidth of the storage pool and within this bandwidth, VoD system 200 can service any content request. However, because all of the content needs to be stored in shared storage subsystem 205, storage expansion is not very granular and storage costs can be high, especially for clusters designed for high streaming throughput.

The direct attach storage model shown in FIG. 3 was designed to address the storage costs and scalability issues presented by the shared storage model. In the direct attach storage model, each server in the cluster has storage directly attached to it, typically trough SCSI interfaces, as depicted in FIG. 3 by servers 310-320 and their attached storage devices 325-335. In contrast to video content stored in shared storage subsystem 205 of VoD system 200 shown in FIG. 2, video content is stored in VoD system 300 in the storage device attached to a server that has the disk space and disk bandwidth to handle the content, as determined by load balancing component 305.

As a result of the direct attach storage model, not all servers in VoD system 300 have immediate access to all of the content stored in the system. When content is ingested into the system, the cluster software agent running on load balancing component 305 decides which server in VoD system 300 should store the content based on resource availability. Conversely, when a user or subscriber places a request for streaming content, the cluster software agent decides which server in VoD system 300 can best service the request.

Content may also be replicated to multiple servers based on content usage to increase the number of concurrent streaming requests serviceable by VoD system 300. Load balancing component 305 ensures resource availability for popular content, i.e., content that is requested with increased frequency, by replicating popular content across multiple servers in VoD system 300.

Because of its multiple storage capabilities, the direct attach storage model provides substantial cost savings compared to the shared storage model. For example, if a customer requires a cluster to provide 5000 streams and 2000 hours of content, a cluster with direct attach storage is able to service the customer requests with a configuration capable of streaming 400 streams and storing 600 hours of content. Additionally, the direct attach storage model enables a scalable cluster VoD system to be granularly scalable. It is possible to start with few servers and add streaming and storage capacity incrementally as the service grows, thus lowering the initial capital expenditure when the system is first launched. Further, components of the system can independently fail without affecting the total system availability.

While an improvement over the shared storage model, the direct attach storage model still does not solve all of the problems generated with usage spikes or when large amounts of content need to be ingested into and streamed from the system in real-time. For example, an unanticipated flashflood may cause content to be unavailable for brief periods. This may occur when the system is close to capacity, a significant number of requests are received near-instantaneously, and the requests involve the same content. When personalized subscription services are available at a cable company headend, for example, that content needs to be ingested, processed to create files that enable pause/fast-forward/fast-reverse and other similar features, and be immediately available to end users. Such requirements present architectural and load balancing challenges that cannot be overcome with the currently-available shared storage and direct attach storage models and their associated load balancing algorithms.

In view of the foregoing, there is a need in this art for a scalable VoD system, method, architecture, and topology that is able to cost-effectively, timely, and easily increase the streaming and storage capacities serviceable when faced with multiple usage patterns and large scale real-time ingest and streaming requests.

There is a further need in this art for a scalable VoD system, method, architecture, and topology capable of effectively managing system resources and balancing different loads to achieve a cost-efficient and high streaming and storage capacity solution for large real-time service demands.

There is also a need in this art for a scalable VoD system, method, architecture, and topology capable of dynamically adjusting to content delivery service demands in a real-time system. That is, a server system capable of automatically and dynamically increasing its capacity for playing out a specific content asset, such as a specific broadcast, DVD, and HD movie quality video, when demand for that asset increases.

### SUMMARY OF THE INVENTION

In view of the foregoing, it is an object of the present invention to provide a scalable VoD system, method, architecture, and topology that is able to cost-effectively, timely, and easily increase the streaming and storage capacities serviceable when faced with multiple usage patterns and large scale real-time ingest and streaming requests.

It is a further object of the present invention to provide a scalable VoD system, method, architecture, and topology capable of effectively managing system resources and balancing different loads to achieve a cost-efficient and high streaming and storage capacity solution for large real-time service demands.

It is also an object of the present invention to provide a scalable VoD system, method, architecture, and topology capable of dynamically adjusting to content delivery service demands in a real-time system.

These and other objects are accomplished by providing a scalable, cluster-based VoD system implemented with a multi-server, multi-storage architecture to serve large scale real-time ingest and streaming requests for content assets. As used herein, content assets include but are not limited to any time-based media content, such as audio, video movies or other broadcast, DVD, or HD movie quality content, or multi-media having analogous video movie components.

In one embodiment, the multi-server, multi-storage architecture is implemented with a cluster of video servers connected to a modified direct attach storage subsystem in which the storage devices attached to the servers are composed of two parts: (1) a title storage, where original content assets are permanently stored; and (2) a cache storage, where temporary copies (replicas) of content assets are kept and used for load balancing.

In another embodiment, the multi-server, multi-storage architecture is implemented with a cluster of two different types of servers to serve large scale real-time requests: (1) library servers, which are servers having large external title storage directly attached to them; and (2) cache servers, which are relatively inexpensive servers having smaller disks that are used only for caching.

In yet another embodiment, the multi-server, multi-storage architecture is implemented with a cluster of library and cache servers using a hybrid shared storage/direct attach model in which the library servers use a shared storage subsystem and the cache servers use a direct attach storage subsystem.

Load balancing is accomplished in the different embodiments of the multi-server, multi-storage architecture through various load balancing algorithms, including, for example: (1) a hot-asset replication algorithm such as the algorithm described in commonly-owned U.S. patent application Ser. No. 10/205,476 entitled “System and Method for Highly-Scalable Real-Time and Time-Based Data Delivery Using Server Clusters” and filed on Jul. 24, 2002, incorporated herein by reference in its entirety; (2) an aggressive caching algorithm; (3) a load-based replication algorithm; and (4) a time-based averaging algorithm. These load balancing algorithms may be implemented in a load balancing component connected to the cluster of servers, or, alternatively, in any one of the servers in the cluster. Further, a replication algorithm is provided to replicate content assets according to each one of the load balancing algorithms.

In the aggressive caching algorithm, content is replicated across multiple caches to ensure that sufficient copies of a given content asset are present to meet demand. For example, a new content asset may be copied to multiple caches, with the number of caches determined generally in any manner desired such as by a system administrator or based on the content asset type, author, title, or genre.

Alternatively, the load-based replication algorithm balances the load by selecting content from servers that are experiencing more service requests and scheduling that content for replication to other servers in the cluster with lower loads.

Further, the time-based averaging algorithm monitors cluster usage patterns and uses the number of recent requests for each content asset stored in the system to project future demand. Future demand may be extrapolated from present usage through any available extrapolation procedure, including averaging and weighted averaging, among others. Content assets may then be replicated across one or more servers in the cluster based on the projected demand.

A cache content reclamation algorithm is implemented to work with the load balancing algorithm and ensure that the cache storage in the system is recycled based on different usage patterns. The cache content reclamation algorithm computes the popularity of a given content asset using a number of parameters, such as frequency of use, use counts over substantially any period of time, content asset type, title, author, genre or any other biographical content asset parameter. These parameters may be evaluated against a content observation window. During the observation window, a retention weight may be assigned to individual content assets or asset groups. A minimum retention period may be enforced to ensure that content assets are not immediately selected for reclamation.

Advantageously, the systems and methods of the present invention provide a cost-efficient and high streaming and storage capacity solution capable of serving multiple usage patterns and large scale real-time service demands. In addition, the systems and methods of the present invention provide a highly-scalable and failure-resistant clustering architecture for streaming content assets in real-time in various network configurations, including wide area networks.

### BRIEF DESCRIPTION OF THE DRAWINGS

The foregoing and other objects of the present invention will be apparent upon consideration of the following detailed description, taken in conjunction with the accompanying drawings, in which like reference characters refer to like parts throughout, and in which:

FIG. 1 is an exemplary diagram of a network and system configuration for delivering streaming video to consumers;

FIG. 2 is an exemplary schematic diagram of a prior-art scalable cluster-based VoD system with shared storage;

FIG. 3 is an exemplary schematic diagram of a prior-art scalable, cluster-based VoD system with direct attach storage;

FIGS. 4A-B are schematic diagrams of a scalable, cluster-based VoD system implemented with a cluster of servers connected to a modified direct attach storage subsystem according to one embodiment of the present invention;

FIG. 5 is a flow chart illustrating exemplary steps taken by the scalable, cluster-based VoD systems of FIGS. 4A-B when storing content assets in the systems;

FIG. 6 is a flow chart illustrating exemplary steps taken by the scalable, cluster-based VoD systems of FIGS. 4A-B when streaming content assets from the systems to consumers;

FIG. 7 is an exemplary schematic diagram of a scalable, cluster-based VoD system implemented with a cluster of library and cache servers where the library servers are directly attached to multiple storage devices according to another embodiment of the present invention;

FIG. 8 is an exemplary schematic diagram of a scalable, cluster-based VoD system implemented with a cluster of library and cache servers where the library servers are connected to a shared storage device according to another embodiment of the present invention;

FIG. 9 is an illustrative diagram of the load balancing algorithms for use with the scalable, cluster-based VoD systems according to the embodiments of the present invention;

FIG. 10 is a flow chart illustrating exemplary steps performed by the aggressive caching algorithm according to the embodiments of the present invention;

FIG. 11 is a flow chart illustrating exemplary steps performed by the load-based replication algorithm according to the embodiments of the present invention;

FIG. 12 is a flow chart illustrating exemplary steps performed by the time-based averaging algorithm according to the embodiments of the present invention;

FIG. 13 is a flow chart illustrating exemplary steps performed by the replication algorithm when replicating media assets for each one of the load balancing algorithms according to the embodiments of the present invention; and

FIG. 14 is a flow chart illustrating exemplary steps performed by the cache reclamation algorithm for reclaiming cache storage space according to an embodiment of the present invention.

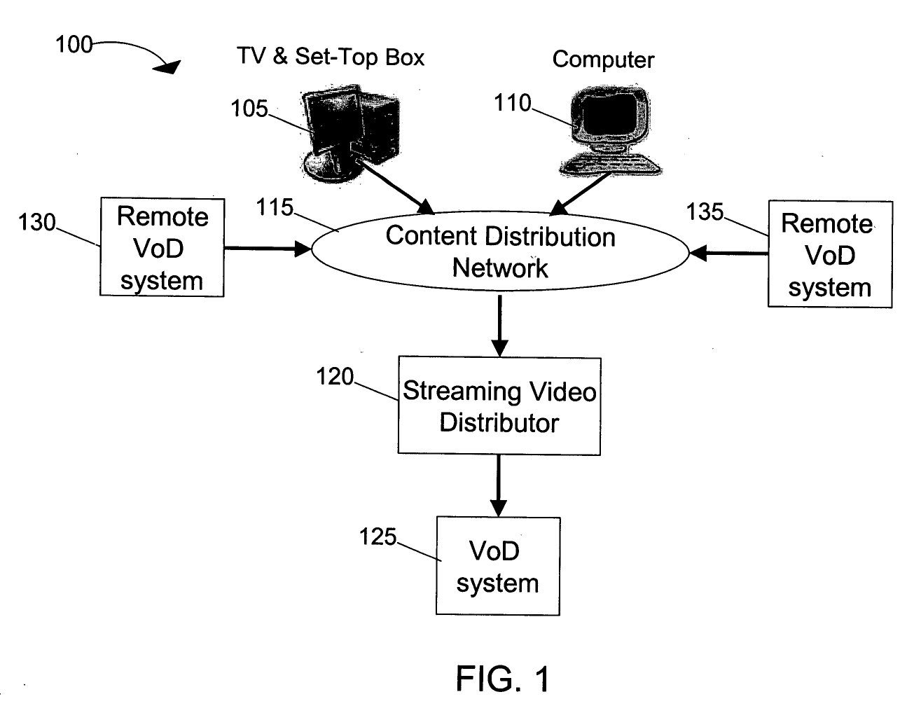

### DETAILED DESCRIPTION OF EMBODIMENTS OF THE INVENTION

Generally, the present invention provides loosely-coupled cluster-based VoD systems comprising a plurality of servers based on storage attached to the plurality of servers. Videos, music, multi-media content, imagery of various types and/or other content assets, are replicated within the system to increase the number of concurrent play requests for the videos, music, multi-media content, or other assets serviceable. For convenience these various videos, movies, music, multi-media content or other assets are referred to as content assets; however, it should be clear that references to any one of these content assets or content asset types, such as to video or movies, refer to each of these other types of content or asset as well.

Content assets as used herein generally refer to data files. Content assets stored in, and streamed from, VoD systems discussed herein preferably comprise real-time or time-based content assets, and more preferably comprise video movies or other broadcast, DVD, or HD movie quality content, or multi-media having analogous video movie components. It will also be appreciated that as new and different high-bandwidth content assets are developed such high-bandwidth content assets benefiting from real-time or substantially real-time play may also be accommodated by the present invention.

Accordingly, the present invention provides a scalable, cluster-based VoD system, method, architecture, and topology for real-time and time-base accurate media streaming. The terms real-time and time-base or time-base accurate are generally used interchangeably herein as real-time play generally meaning that streaming or delivery is time-base accurate (it plays at the designated play rate) and is delivered according to some absolute time reference (that is there is not too much delay between the intended play time and the actual play time). In general, real-time play is not required relative to a video movie but real-time play or substantially real-time play may be required or desired for a live sporting event, awards ceremony, or other event where it would not be advantageous for some recipients to receive the content asset with a significant delay relative to other recipients.

For example, it is desirable that all requesting recipients of a football game would receive both a time-base accurate rendering or play out and that the delay experienced by any recipient be not more than some predetermined number of seconds (or minutes) relative to another requesting recipient. The actual time-delay for play out relative to the live event may be any period of time where the live event was recorded for such later play.

Streaming, as used herein, generally refers to distribution of data. Aspects of the invention further provide computer program software/firmware and computer program product storing the computer program in tangible storage media. By real-time (or time-based) streaming, herein is meant that assets stored by or accessibly by the VoD system are generally transmitted from the VoD system at a real-time or time-base accurate rate. In other words the intended play or play out rate for a content asset is maintained precisely or within a predetermined tolerance.

Generally, for movie video streaming using compression technology available today from the Motion Pictures Expert Group, (MPEG), a suitable real-time or time-base rate is 4 to 8 Megabits/second, transmitted at 24 or 30 frames/second. Real-time or time-base asset serving maintains the intended playback quality of the asset. It will be appreciated that in general, service or play of an ordinary Internet web page or video content item will not be real-time or time-base accurate and such play may appear jerky with a variable playback rate. Even where Internet playback for short video clips of a few to several seconds duration may be maintained, such real-time or time-base accurate playback cannot be maintained over durations of several minutes to several hours.

VoD systems according to the present invention may be described as or referred to as cluster systems, architectures, or topologies. That is, the VoD systems comprise a plurality of servers in communication (electrical, optical, or otherwise) with each other. A variety of servers for use with the present invention are known in the art and may be used, with MediaBase™ servers made by Kasenna, Inc. of Mountain View, Calif. being particularly preferred. Aspects of server systems and methods for serving content assets are described in U.S. patent application Ser. No. 09/916,655, entitled “Improved Utilization of Bandwidth in a Computer System Serving Multiple Users” and filed on Jul. 27, 2001; U.S. patent application Ser. No. 08/948,668, entitled “System For Capability Based Multimedia Streaming over A Network” and filed on Oct. 14, 1997; U.S. patent application Ser. No. 10/090,697, entitled “Transfer File Format And System And Method For Distributing Media Content” and filed on Mar. 4, 2002; and U.S. patent application Ser. No. 10/205,476 entitled “System and Method for Highly-Scalable Real-Time and Time-Based Data Delivery Using Server Clusters” and filed on Jul. 24, 2002, each of which applications is hereby incorporated by reference.

Each server within the VoD system generally comprises at least one processor and is associated with a computer-readable storage device, such as a disk or an integrated memory or other computer-readable storage media, which stores content asset information. Content asset information generally comprises all or part of the asset, or metadata associated with the asset. A plurality of processors or microprocessors may be utilized in any given server.

The present invention further provides methods and systems and computer program and computer program product for load balancing content assets, as described in more detail hereinbelow. As used herein, load balancing refers to the ability of a system to divide its work load among different system components so that more work is completed in the same amount of time and, in general, all users get served faster. Load balancing may be implemented in software, hardware, or a combination of both.

An exemplary scalable cluster-based VoD system, method, architecture, and topology that is able to cost-effectively, timely, and easily increase the streaming and storage capacity of prior-art VoD systems was developed and described in co-pending and commonly-owned U.S. patent application Ser. No. 10/205,476 (“the '476 application”) entitled “System and Method for Highly-Scalable Real-Time and Time-Based Data Delivery Using Server Clusters” and filed on Jul. 24, 2002, incorporated herein by reference in its entirety. Embodiments of the exemplary scalable cluster-based VoD system are also embedded in the Video Delivery Platform (VDP) and the Video Services Platform (VSP) line of products sold by Kasenna, Inc., of Mountain View, Calif.

The scalable, cluster-based VoD system described in the '476 application is formed by a group or cluster of servers that share physical proximity and are connected through a network, either a local area network (LAN) or a wide area network (WAN). The cluster has a single virtual address (SVA) that can be enabled via a load balancing component, such as a Layer-2, a Layer-4, or a Layer-7 switch, among others. The load balancing component receives all the content requests directed to the cluster by users or subscribers to the system and forwards the requests to one of the servers in the cluster. Alternatively, a load balancing component may be omitted in favor of using one of the servers in the cluster as central dispatcher to receive and handle or redirect content requests to servers in the cluster.

The scalable, cluster-based VoD system described in the '476 application is also implemented to share content metadata information across all servers in the clusters. Metadata information is information about content such as content availability, server status, current load, and server type, i.e., whether ingest, streaming server, or both. Shared content metadata enables any server in the cluster to receive a content request, handle the request or forward the request to another server in the cluster with the resources and capabilities to handle the request. Shared content metadata is implemented by using a cluster software agent that runs on every server to communicate metadata information periodically. The cluster software agent also keeps track of the current load average in each server based on monitored system resources, such as CPU usage, free physical and swap memory, available network bandwidth, among others.

The cluster implementation enables the VoD system to scale near-linearly, support a multitude of content usage patterns, provide increased system availability such that a component failure will not make the complete system unavailable, use off-the-shelf components, i.e., hardware, storage, network interface cards, file systems, etc., without any modifications, and be cost-effective. Further, the cluster implementation enables content to be stored very efficiently, without having to store the same content in all servers in the system.

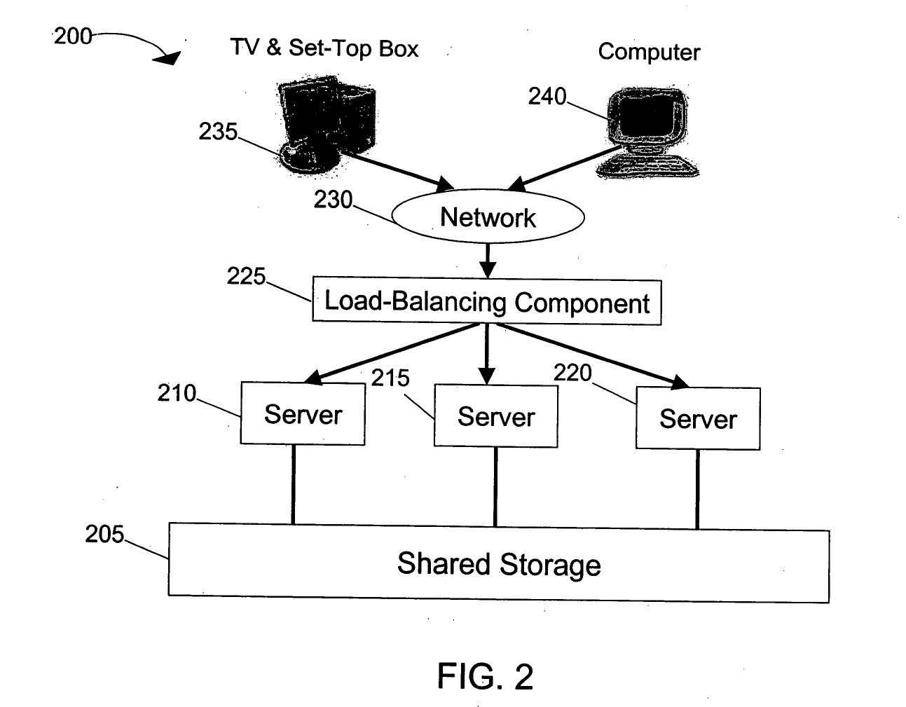

The scalable, cluster-based VoD system described in the '476 application may be implemented using two different storage models: (1) a shared storage model; or (2) a direct attach storage model. In the shared storage model shown in FIG. 2, a cluster of servers is connected to a shared storage subsystem, such as a storage area network that is connected using a fiber channel interface or a network-attached storage subsystem. Storage is made available in the form of one or more shared file systems. In scalable cluster-based VoD system 200, streaming video resides on shared storage subsystem 205. Individual servers, such as servers 210-220, store metadata locally. Installing video content into VoD system 200 generally involves installing the content on shared storage subsystem 205 and distributing the metadata associated with the video to all servers in VoD system 200.

One of the advantages of the shared storage model is that video content is uniformly accessible to all servers in VoD system 200. The maximum number of playouts is usually bounded by the bandwidth of the storage pool and within this bandwidth, VoD system 200 can service any content request. However, because all of the content needs to be stored in shared storage subsystem 205, storage expansion is not very granular and storage costs can be high, especially for clusters designed for high streaming throughput.

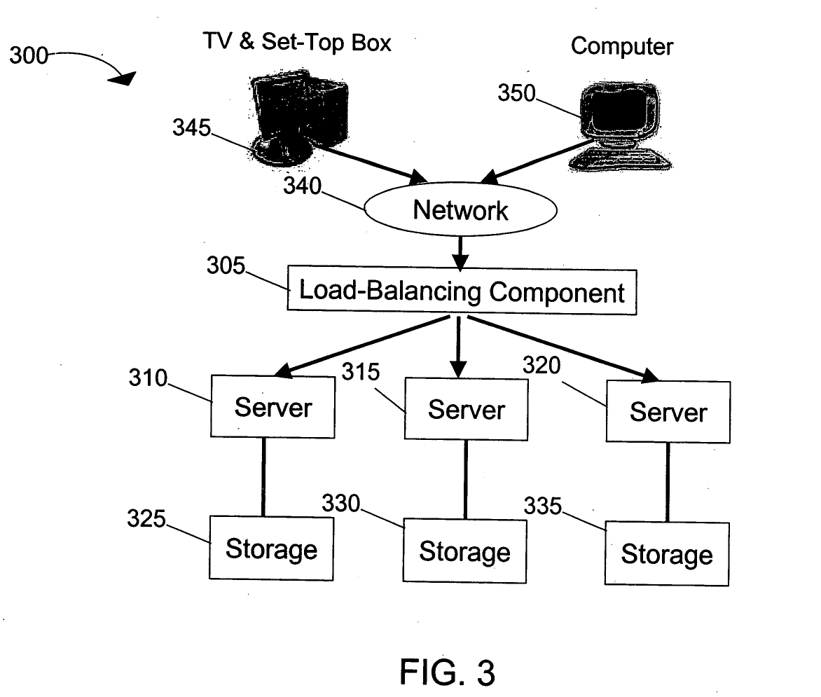

The direct attach storage model shown in FIG. 3 was designed to address the storage costs and scalability issues presented by the shared storage model. In the direct attach storage model, each server in the cluster has storage directly attached to it, typically trough SCSI interfaces, as depicted in FIG. 3 by servers 310-320 and their attached storage devices 325-335. In contrast to video content stored in shared storage subsystem 205 of VoD system 200 shown in FIG. 2, video content is stored in VoD system 300 in the storage device attached to a server that has the disk space and disk bandwidth to handle the content, as determined by load balancing component 305.

As a result of the direct attach storage model, not all servers in VoD system 300 have immediate access to all of the content stored in the system. When content is ingested into the system, the cluster software agent running on load balancing component 305 decides which server in VoD system 300 should store the content based on resource availability. Conversely, when a user or subscriber places a request for streaming content, the cluster software agent decides which server in VoD system 300 can best service the request.

Content may also be replicated to multiple servers based on content usage to increase the number of concurrent streaming requests serviceable by VoD system 300. Load balancing component 305 ensures resource availability for popular content, i.e., content that is requested with increased frequency, by replicating popular content across multiple servers in VoD system 300.

Because of its multiple storage capabilities, the direct attach storage model provides substantial cost savings compared to the shared storage model. For example, if a customer requires a cluster to provide 5000 streams and 2000 hours of content, a cluster with direct attach storage is able to service the customer requests with a configuration capable of streaming 400 streams and storing 600 hours of content. Additionally, the direct attach storage model enables a scalable cluster VoD system to be granularly scalable. It is possible to start with few servers and add streaming and storage capacity incrementally as the service grows, thus lowering the initial capital expenditure when the system is first launched. Further, components of the system can independently fail without affecting the total system availability.

While an improvement over the shared storage model, the direct attach storage model still does not solve all of the problems generated with usage spikes or when large amounts of content need to be ingested into and streamed from the system in real-time. For example, an unanticipated flashflood may cause content to be unavailable for brief periods. This may occur when the system is close to capacity, a significant number of requests are received near-instantaneously, and the requests involve the same content. When personalized subscription services are available at a cable company headend, for example, that content needs to be ingested, processed to create files that enable pause/fast-forward/fast-reverse and other similar features, and be immediately available to end users. Such requirements present architectural and load balancing challenges that cannot be overcome with the currently-available shared storage and direct attach storage models and their associated load balancing algorithms.

To address the scalability and resource-management problems of the scalable, cluster-based VoD system described in the '476 application, higher performance and more cost effective embodiments of a scalable, cluster-based VoD system are described hereinbelow. The embodiments disclosed herein are capable of serving large scale real-time ingest and streaming requests with highly-scalable and failure resistant architectures. The architectures implement sophisticated load balancing algorithms for distributing the load among the servers in the cluster to achieve a high streaming and storage capacity solution capable of servicing multiple usage patterns and streaming content assets in real-time in various network configurations.

I. Exemplary Scalable Cluster-Based VoD System Architectures

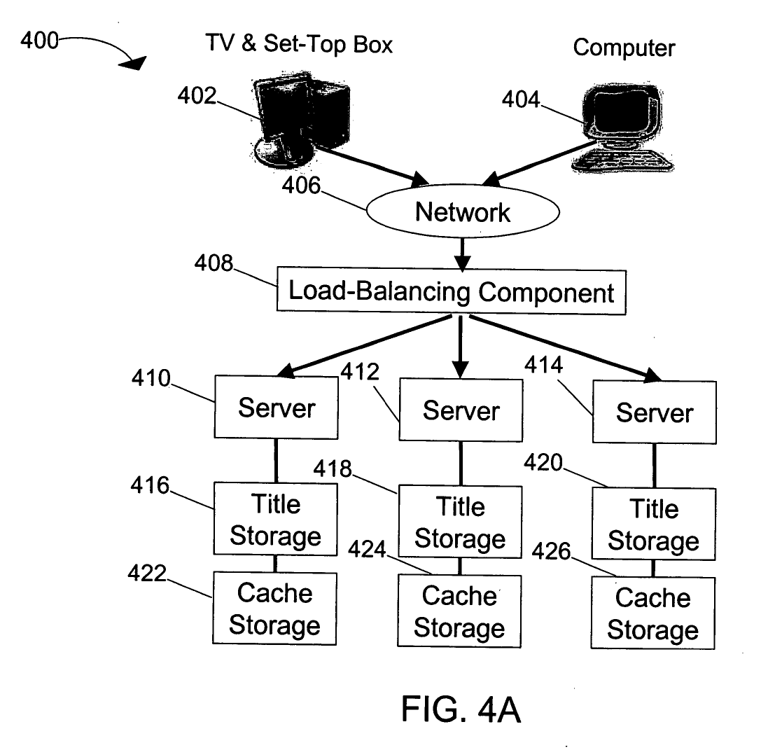

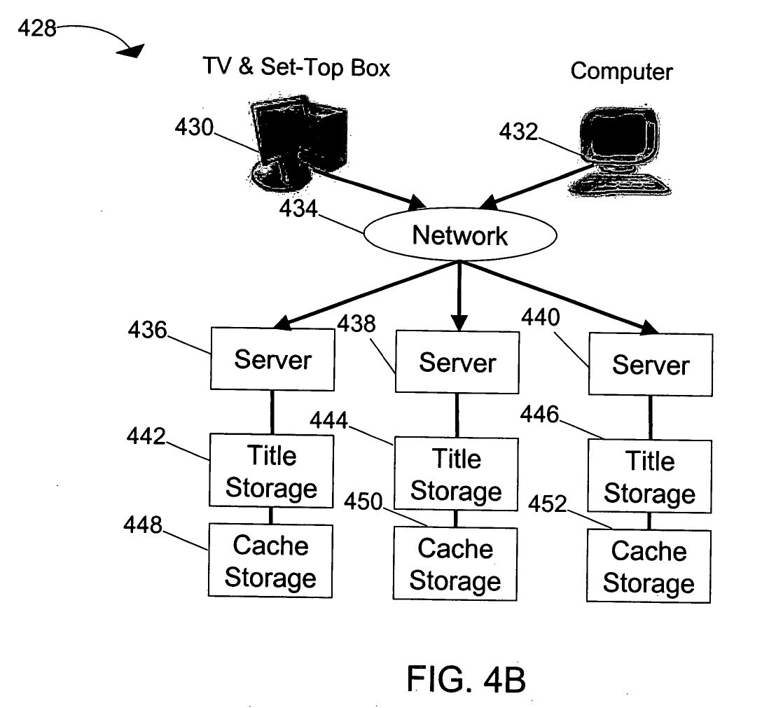

Referring now to FIG. 4A, a schematic diagram of a scalable cluster-based VoD system implemented with a cluster of servers connected to a modified direct attach storage subsystem according to one embodiment of the present invention is described. VoD system 400 comprises a cluster of servers 410-414 that are connected to network 406 for servicing streaming media requests from consumers 402-404. Network 406 may be a local or wide area network or any other network connection capable of streaming content assets to consumers 402-404.

Servers 410-414 each comprise a computer-readable storage medium encoded with a computer program module that, when executed by at least one processor, enables the server to broadcast load information, receive and store load information, and/or provide the load balancing functionalities described further below. Alternatively, these functionalities may be provided by a plurality of computer program modules.

Servers 410-414 are in communication with one another. In system 400, servers 410-414 are in communication via network 406. In other embodiments, servers 410-414 are in communication via network 406 for streaming, and have a separate connection (for example, a direct or wireless connection) for messaging amongst each other. Other communication means and/or protocols may be utilized as are known in the art for coupling computers, networks, network devices, and information systems in VoD system 400.

User requests may come to servers 410-414 as, for example, a hyper-text transport protocol (HTTP) or real time streaming protocol (RTSP) request, although a variety of other protocols known in the art are suitable for forming user requests. The requests are directed via load balancing component 408 to one of the servers in the cluster according to one of the load balancing algorithms running in load balancing component 408 and described in more detail hereinbelow. Load balancing component 408 also has a plurality of software agents for sharing content asset metadata information among servers 410-414 and handling content asset requests made by consumers 402-404.

In preferred embodiments, load balancing component 408 comprises a Layer-4 or Layer-7 switch. In other embodiments, load-balancing component 408 comprises a software load balancing proxy or round-robin DNS. These and other load-balancing components are known in the art.

Each server in VoD system 400 is associated with its own independent storage that is composed of two parts: (1) a title storage, where original content assets are stored; and (2) a cache storage, where temporary copies (replicas) of content assets are kept and used for load balancing according to one of the load balancing algorithms described hereinbelow. For example, server 410 is connected to tile storage 416 and cache storage 422, server 412 is connected to title storage 418 and cache storage 424, and server 414 is connected to title storage 420 and cache storage 426.

Content assets reside on computer-readable storage devices 416-426. Content assets, as discussed above, are preferably data files requiring real-time delivery, and more preferably video files. Generally any media format may be supported with MPEG-1, MPEG-2, and MPEG-4 formats being preferred. Installing a content asset into the cluster generally requires an administrator, or other authorized user, to determine which server or servers should host the content asset and install the content asset on those servers. Adding additional servers preloaded with content asset information can increase the throughput of VoD system 400.

Referring now to FIG. 4B, a variation of VoD system 400 shown in FIG. 4A is described. VoD system 428 shown in FIG. 4B contains the same components and performs the same functions as VoD system 400 shown in FIG. 4A, with the exception of a load balancing component. In VoD system 428, load balancing is effectively performed by one of the servers in VoD system 428, namely, servers 436-440 according to the load balancing algorithms described in more detail hereinbelow. The server performing load balancing functions also acts as a central dispatcher and runs software agents to handle content asset requests directed to servers 436-440 by consumers 430-432.

In this embodiment, a Level-2 switch may be provided as an interface between servers 436-440 within VoD system 428 and network 434. It should be understood by one skilled in the art that the cost of a simple Layer-2 switch is a fraction of the cost of a Layer-4 load balancing component, so that embodiments of the invention without a load balancing component provide considerable cost savings and economies over those embodiments requiring an external load balancing component.

It should be understood by one skilled in the art that the number of library, cache servers and consumers shown in FIGS. 4A-B is shown for illustrative purposes only. More library and cache servers may be added to VoD systems 400 and 428 as desired, making VoD systems 400 and 428 fully scalable and capable of handling large scale real-time streaming media requests for a large number of consumers.

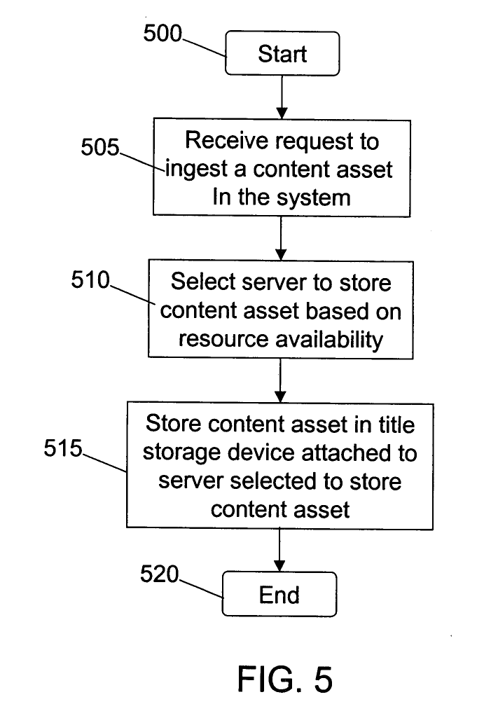

Referring now to FIG. 5, a flow chart illustrating exemplary steps taken by the scalable, cluster-based VoD systems of FIGS. 4A-B when storing content assets in the systems is described. When a request for a content asset to be stored in the VoD system is placed (step 505), software agents running on a load balancing component or on one of the servers in the system selected to act as a central dispatcher decide which server in the system can best service the request based on resource availability and according to the load balancing algorithms described in more detail hereinbelow (step 510).

That is, the software agents decide which server should store an original copy of the content asset for streaming to consumers by any one of the servers in the cluster of servers within the VoD system. The content asset is then stored in the title storage device attached to the selected server (step 515).

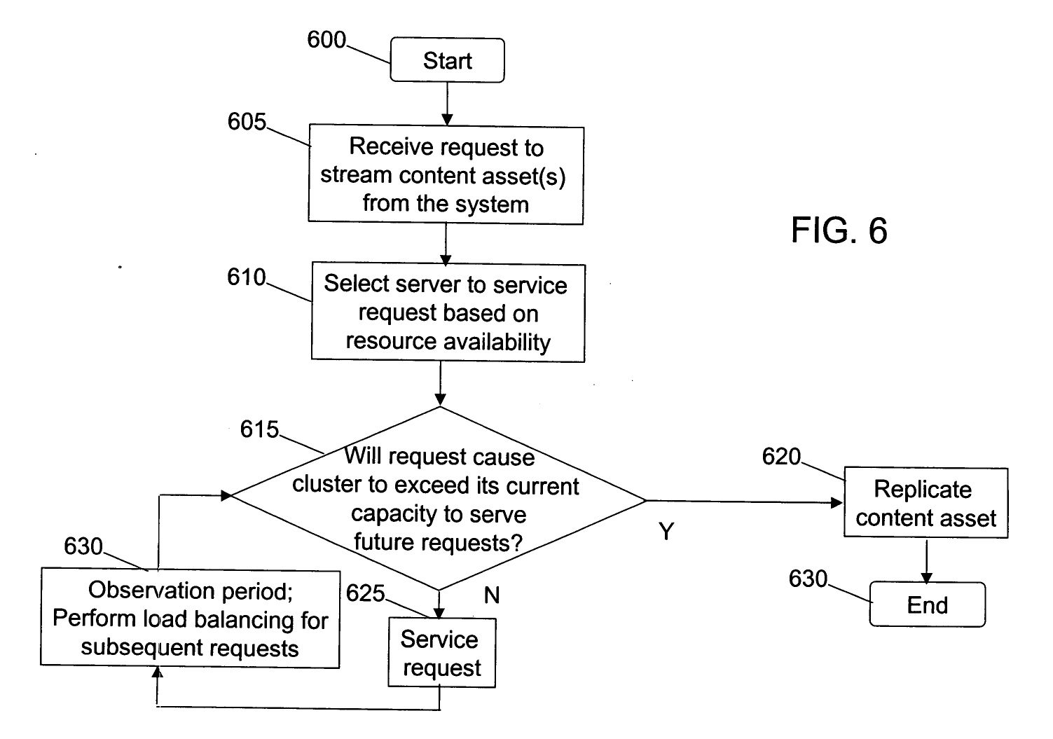

Referring now to FIG. 6, a flow chart illustrating exemplary steps taken by the scalable cluster-based VoD systems of FIGS. 4A-B when streaming content assets from the systems to consumers is described. When a request for a content asset to be streamed from the system to one or more consumers is placed (step 605), software agents running on a load balancing component or on one of the servers in the system selected to act as a central dispatcher decide which server(s) in the system can best service the request based on resource availability and according to the load balancing algorithms described in more detail hereinbelow (step 610).

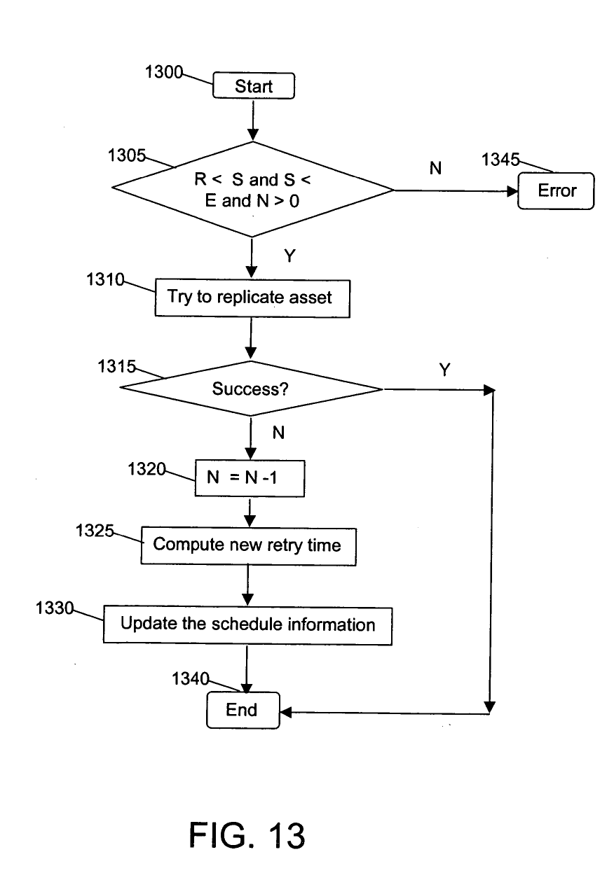

If the software agents determine that the streaming media request will cause the cluster to exceed its current capacity to service future requests as determined by the available resources (step 615), a replica of the content is then made on another server's cache storage device by the replication algorithm described hereinbelow with reference to FIG. 13. Otherwise, the request is serviced by the selected server(s) (step 625). The software agents then start an observation period during which subsequent streaming media requests are load balanced among the servers in the cluster according to the load balancing algorithms described in more detail hereinbelow (step 630).

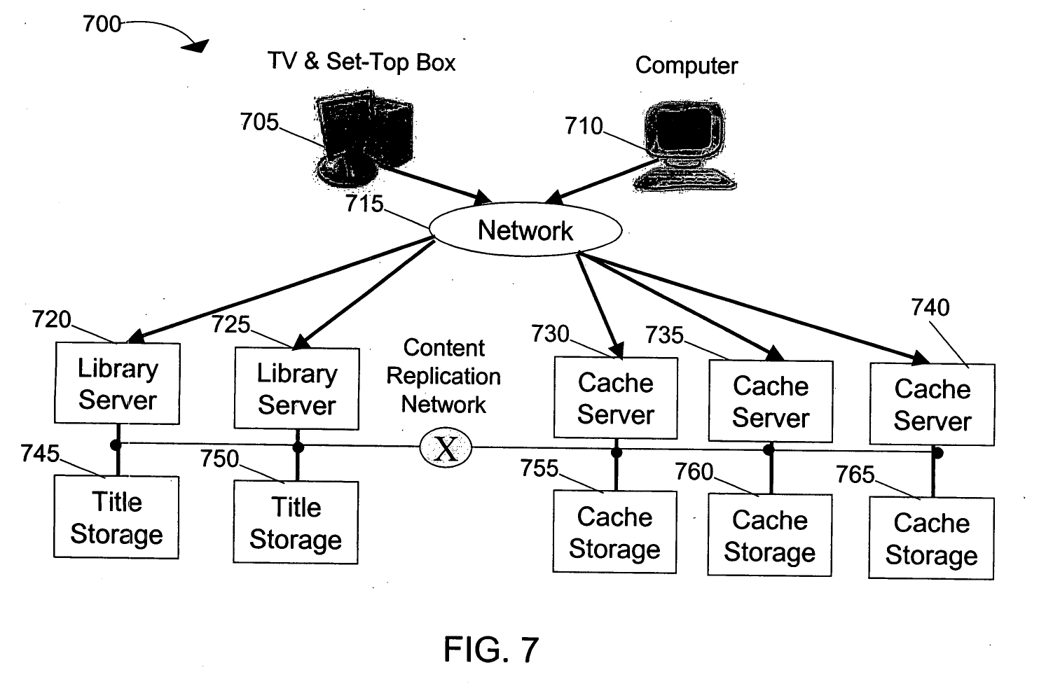

Referring now to FIG. 7, an exemplary schematic diagram of a scalable cluster-based VoD system implemented with a cluster of library and cache servers where the library servers are directly attached to multiple storage devices according to another embodiment of the present invention is described.

VoD system 700 comprises a cluster of servers 720-740 that are connected to network 715 for servicing streaming media requests from consumers 705-710. Network 715 may be a local or wide area network or any other network connection capable of streaming content assets to consumers 705-710.

Servers 720-740 each comprise a computer-readable storage medium encoded with a computer program module that, when executed by at least one processor, enables the server to broadcast load information, receive and store load information, and/or provide the load balancing functionalities described further below. Alternatively, these functionalities may be provided by a plurality of computer program modules.

Servers 720-740 are in communication with one another. In system 700, servers 720-740 are in communication via network 715. In other embodiments, servers 720-740 are in communication via network 715 for streaming, and have a separate connection (for example, a direct or wireless connection) for messaging amongst each other. Other communication means and/or protocols may be utilized as are known in the art for coupling computers, networks, network devices, and information systems. User requests come to servers 720-740 as, for example, a hyper-text transport protocol (HTTP) or real time streaming protocol (RTSP) request, although a variety of other protocols known in the art are suitable for forming user requests.

In system 700, servers 720-725 are library servers directly connected to large title storage devices 745-750, which typically do not have any cache storage. All of the content assets ingested into the system are stored in title storage devices 745-750 attached to library servers 720-725. Library servers 720-725 are typically RAID-protected, e.g. RAID level 5, so that content availability under disk failures is guaranteed.

Library servers 720-725 are capable of streaming the content assets stored in title storage devices 745-750 directly to consumers 705-710. Alternatively, content assets stored in title storage devices 745-750 may be replicated to one of cache servers 730-740 based on resource availability, usage patterns, and according to the load balancing algorithms described in more detail hereinbelow. Content assets are replicated from library servers 720-725 to cache servers 730-740 and between cache servers 730-740 to maximize system resources.

Since all of the content assets in system 700 are available in library servers 720-725, cache servers 730-740 are relatively inexpensive with smaller attached cache storage devices 755-765 that are used only for caching. Further, since there is no need for content protection in cache servers 730-740 as all of the content is available in library servers 720-725, there is also no need for expensive components such as RAID controllers to be added to cache servers 730-740.

System resources are also maximized by having a cache-first load balancing policy for selecting a cache server among cache servers 730-740 to serve streaming requests to clients. Streaming requests may be served out of cache servers 730-740 for popular content assets or other content assets depending on resource availability and whether real-time play is requested. Alternatively, streaming requests may be served out of library servers 720-725 for content assets that are not so popular and do not have a replica in a cache server.

VoD system 700 may provide real-time play by having library servers 720-725 or cache servers 730-740 play out content assets as they are being ingested into the system. Content metadata is exchanged among servers 720-740 to redirect clients to the appropriate server while an ingest is in progress. Once the ingest is complete, VoD system 700 distributes its load in the cluster of servers by running the load balancing algorithms described in more detail hereinbelow.

Advantageously, VoD system 700 scales storage and streaming needs independently and cost-effectively. If additional streams are required, inexpensive cache servers such as cache servers 730-740 can be easily added. If additional storage is required, external storage such as title storage devices 745-750 can be expanded or additional library servers such as library servers 720-725 can be added.

It should be understood by one skilled in the art that any one of servers 720-740 may optionally perform load balancing functions according to the load balancing algorithms described in more detail hereinbelow or according to other known load balancing methods known in the art. Alternatively, it should also be understood by one skilled in the art that a load balancing component such as a Layer-4 switch may perform load balancing functions for the cluster of servers 720-740 similar to load balancing component 408 shown in FIG. 4A.

It should further be understood by one skilled in the art that the number of library, cache servers and consumers shown in FIG. 7 is shown for illustrative purposes only. More library and cache servers may be added to VoD system 700 as desired, making VoD system 700 fully scalable and capable of handling large scale real-time streaming media requests for a large number of consumers.

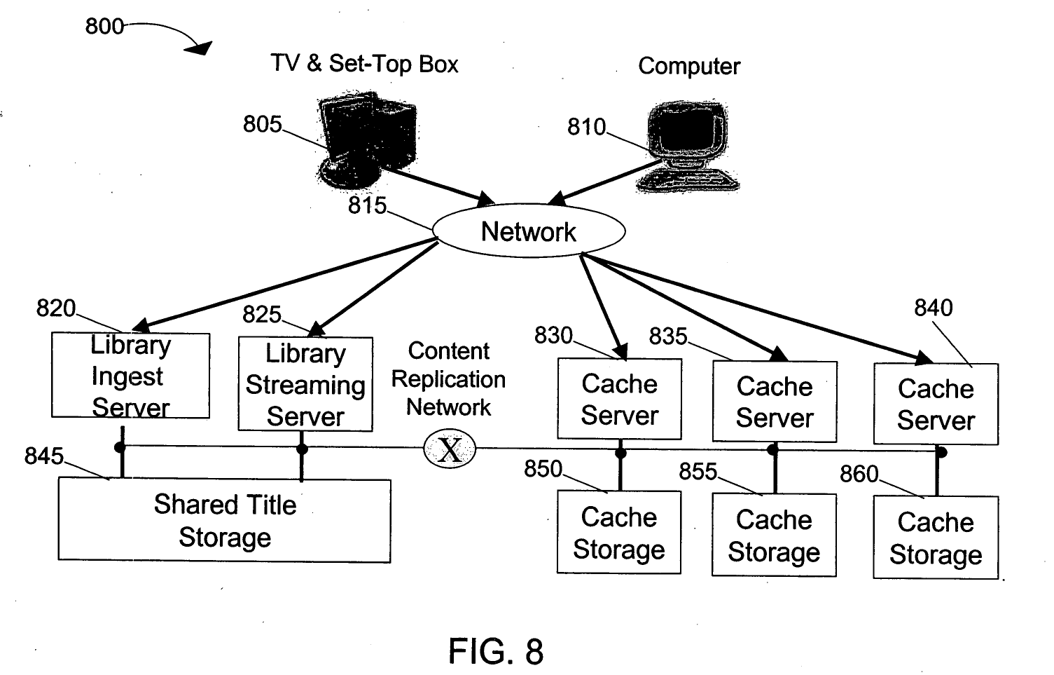

Referring now to FIG. 8, an exemplary schematic diagram of a scalable cluster-based VoD system implemented with a cluster of library and cache servers where the library servers are connected to a shared storage device according to another embodiment of the present invention is described.

VoD system 800 is a variation of VoD system 700 shown in FIG. 7. In VoD system 800, library servers 820-825 are connected to shared title storage device 845. Real-time content is ingested into library ingest server 820. Library ingest server 820 then processes the incoming content and stores the processed content in shared title storage device 845. The ingested content is immediately available for streaming from shared title storage device 845 directly to consumers 805-810 from library streaming server 825.

In case streaming requirements exceed the bandwidth available in shared title storage device 845, content assets stored therein may be replicated to cache servers 830-840 based on resource availability, usage patterns, and according to the load balancing algorithms described in more detail hereinbelow.

Advantageously, VoD system 800 is capable of handling large amounts of content assets in real-time. In particular, VoD system 800 is capable of handling flash-flood events and ensuring real-time content availability in the presence of server or storage failures.

It should be understood by one skilled in the art that any one of servers 820-740 may perform load balancing functions according to the load balancing algorithms described in more detail hereinbelow. Alternatively, it should also be understood by one skilled in the art that a load balancing component such as a Layer-4 switch may perform load balancing functions for the cluster of servers 820-840 similar to load balancing component 408 shown in FIG. 4A.

Additionally, it should be understood by one skilled in the art that library servers 820-825 may interchangeably act as ingest, streaming servers or both. It should also be understood by one skilled in the art that storage devices attached to library servers 820-825 may be a shared storage device such as shared title storage 845, direct attach storage devices such as title storage devices 745-750 shown in FIG. 7 or a combination of a shared storage device and direct attach storage devices.

It should further be understood by one skilled in the art that the number of library, cache servers and consumers shown in FIG. 8 is shown for illustrative purposes only. More library and cache servers may be added to VoD system 800 as desired, making VoD system 800 fully scalable and capable of handling large scale real-time streaming media requests for a large number of consumers.

II. Exemplary Load Balancing Algorithms and Procedures

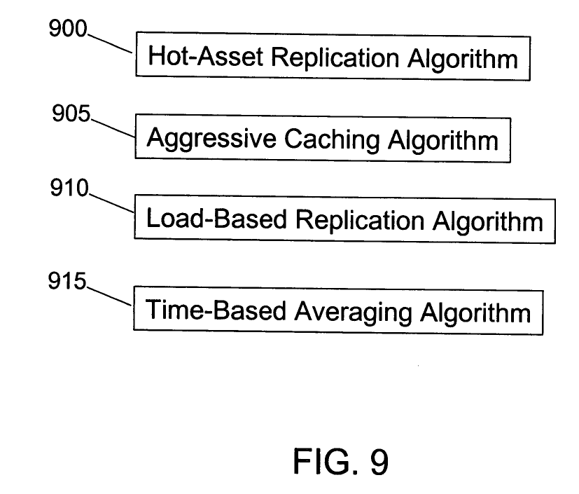

Referring now to FIG. 9, an illustrative diagram of the load balancing procedures and algorithms for use with the scalable, cluster-based VoD systems according to the embodiments of the present invention is described. These algorithms and procedures may advantageously be implemented as computer software programs that include executable computer program instructions and optional non-executable computer program components. Load balancing is accomplished using the multi-server, multi-storage architectures described herein, such as for example the exemplary architectures shown in FIGS. 4A-B, 7, and 8 through the optional use of various load balancing algorithms, including, for example: (1) hot-asset replication algorithm 900 as described in commonly-owned U.S. patent application Ser. No. 10/205,476 entitled “System and Method for Highly-Scalable Real-Time and Time-Based Data Delivery Using Server Clusters” and filed on Jul. 24, 2002, incorporated herein by reference in its entirety; (2) aggressive caching algorithm 905; (3) load-based replication algorithm 910; and (4) time-based averaging algorithm 915. These load balancing algorithms may be implemented in a load balancing component connected to the cluster of servers, or, alternatively, in any one of the servers in the clusters of VoD systems shown in FIGS. 4A-B, 7, and 8.

It should be understood by one skilled in the art that additional load balancing algorithms may be implemented in VoD systems 400, 428, 700, and 800, as desired. Such algorithms may run concurrently with or separately from load balancing algorithms 900-915.

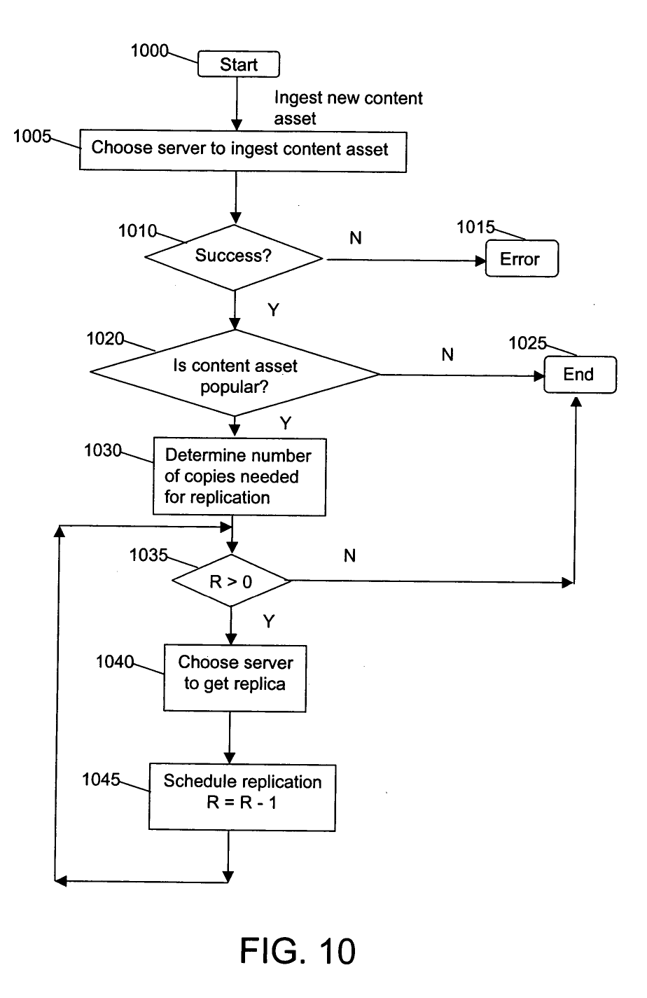

Referring now to FIG. 10, a flow chart illustrating exemplary steps performed by the aggressive caching algorithm according to the embodiments of the present invention is described. With the aggressive caching algorithm, content is replicated across multiple caches to ensure that sufficient copies of a given content asset are present to meet demand. For example, a new content asset may be copied to multiple caches, with the number of caches determined generally in any manner desired such as by a system administrator or based on the content asset type, author, title, or genre.

The aggressive caching algorithm works as follows. When a request to ingest a new content asset in the VoD system is placed, a server is selected within the cluster of servers of one of VoD systems shown in FIGS. 4A-B, 7, or 8 to receive and store the content asset in its associated storage, which may be a shared storage device shared by all servers within the cluster, or a storage device directly attached to the server (step 1005). It should be understood by one skilled in the art that when library servers are used, the content asset is preferably stored in one of the library servers. It should also be understood by one skilled in the art that when a modified direct attach storage subsystem as shown in FIGS. 4A-B is used, the content asset is preferably stored in the title storage device associated with the server.

The server selected to receive and store the content asset in its associated storage is selected based on one or a combination of the following parameters: (1) free title storage in the server; (2) the percentage of free title storage in the server; (3) streaming capacity of the server; and (4) association between content assets stored in the server, for example, a content asset including the trailer of a movie and another content asset including the movie itself.

After the content asset is stored, the aggressive caching algorithm checks whether the content asset is a popular asset (step 1020). A content asset is deemed popular if it is explicitly specified as such or if the system assigns the content asset to be popular as a default option in the VoD system.

If the content asset is indeed deemed to be a popular content asset, then that asset is to be replicated to one or more servers in the VoD system. Accordingly, the content asset is replicated to a cache storage device associated with the server if the VoD system architecture shown in FIGS. 4A-B is used, or replicated to a cache server if the VoD system architecture shown in FIG. 7 or 8 is used.

Before replicating the content asset, the aggressive caching algorithm determines the number of copies needed for replication (step 1030). For each copy needed to be replicated, a server within the cluster is chosen to store the replica in its associated storage device (step 1040). The server chosen for storing the replica is selected based on one or a combination of the following parameters: (1) total cache storage; (2) streaming capacity; and (3) association between content assets stored in the server. Lastly, the content asset is replicated according to the steps performed by the replication algorithm illustrated in FIG. 13 (step 1045).

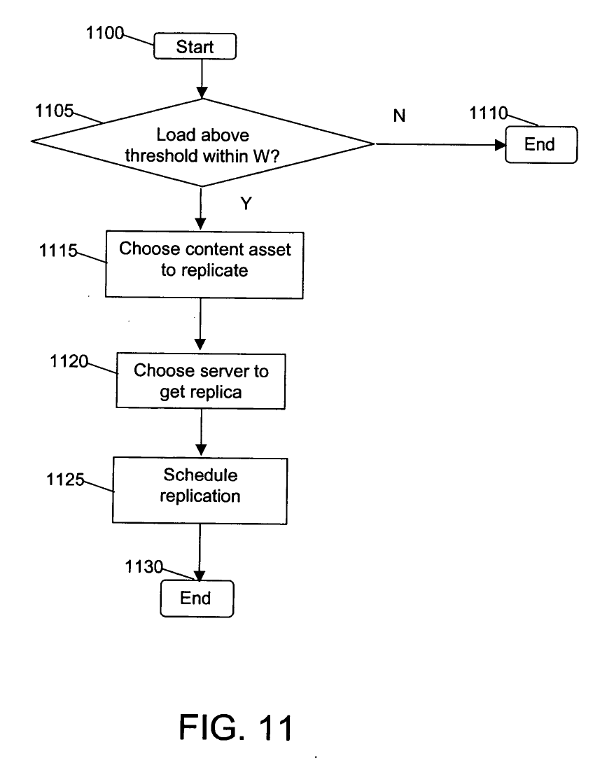

Referring now to FIG. 11, a flow chart illustrating exemplary steps performed by the load-based replication algorithm according to the embodiments of the present invention is described. The load-based replication algorithm balances the load in the VoD system by selecting content from servers that are experiencing more service requests and scheduling that content for replication to other servers in the cluster with lower loads.

The load-based replication algorithm works by monitoring the load of each server in the cluster within an observation window, typically 15 minutes. If the server load exceeds a predetermined threshold—either absolute or relative to other clusters in the server—during the observation window (step 1105), a content asset stored in the server's associated storage device is selected for replication (step 1115). The content asset is selected based on the number of requests made for that content asset within a predetermined time window in the past.

The content assets in the server may then be sorted according to the number of previous requests made for each content asset in the server. Content assets that already have more than one copy in the cluster or content assets that do not have sufficient previous requests based on a predetermined threshold may be excluded. The content asset selected is that with the highest number of former requests.

A server is then selected to receive the replica of the content asset (step 1120). The server may be selected based on one or a combination of the following parameters: total cache storage and streaming capacity. Lastly, the content asset is replicated according to the steps performed by the replication algorithm illustrated in FIG. 13.

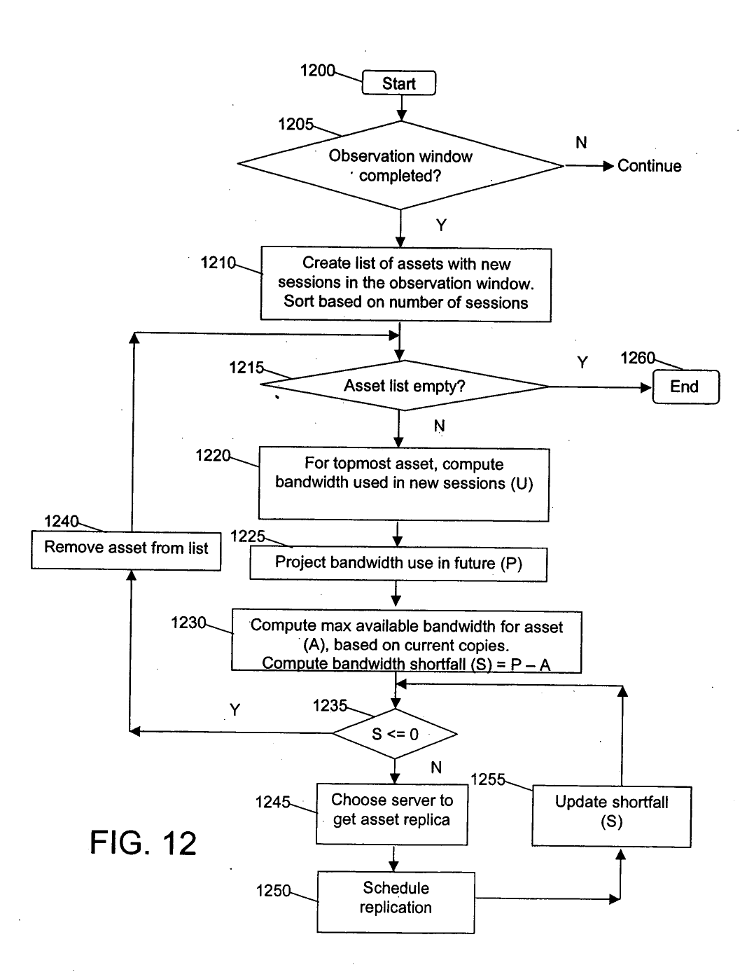

Referring now to FIG. 12, a flow chart illustrating exemplary steps performed by the time-based averaging algorithm according to the embodiments of the present invention is described. The time-based averaging algorithm monitors cluster usage patterns and uses the number of recent requests for each content asset stored in the system to project future demand. Usage patterns are monitored for different observation windows, for example, for windows of 1 min, 5 min, and 15 min. The observation windows are rolled out at certain intervals, typically smaller than the window itself.

When a given observation window is completed (step 1205), a list of content assets that had new streaming requests within the observation window is created (step 1210). The list may be sorted based on the number of streaming sessions for each content asset in the list. If the list of content assets has at least one asset (step 1215), the bandwidth used by the new session requests in the observation window for the topmost content asset in the list is computed (step 1220). This bandwidth is denoted as “U”.

Future demand for that content asset is then projected using linear projection over a specified period (step 1225). The linear projection is refined by weights that are associated with the observation window. Future demand for the content asset is denoted “P”.

The maximum available bandwidth for the content asset is then determined based on the current copies of the content asset stored in the cluster (step 1230). The maximum available bandwidth is denoted “A”. The bandwidth shortfall for that content asset, denoted “S”, is the difference between the projected future demand and the maximum available bandwidth for the asset, that is, S=P−A.

In case there will be a projected shortfall for the content asset in the future (step 1235), the content asset is chosen to be replicated in a server (step 1245). The server may be selected based on either one or a combination of the following parameters: (1) total cache space; (2) streaming capacity; and (3) the last time a replica was made in the server. Lastly, the content asset is replicated according to the steps performed by the replication algorithm illustrated in FIG. 13.

Referring now to FIG. 13, a flow chart illustrating exemplary steps performed by the replication algorithm when replicating content assets for each one of the load balancing algorithms according to the embodiments of the present invention is described. As described hereinabove with reference to load balancing algorithms 905-915, content assets are replicated to one or more servers in the VoD system, that is, copies of content assets stored in one server are made and stored in another server(s), to satisfy multiple usage patterns and large scale real-time streaming demands.

A replication may be attempted numerous times by keeping track of the following parameters: (1) replication start time (“S”); (2) replication end time (“E”); (3) maximum number of replication attempts (“N”); (4) priority of the replication (“P”); (5) load balancing algorithm requesting the replication, i.e., whether hot asset algorithm 900, aggressive caching algorithm 905, load-based replication algorithm 910, or time-based averaging algorithm 915; and (6) retry time (“R”). Each replication is attempted as soon as the start time S elapses, that is, as soon as S=R.

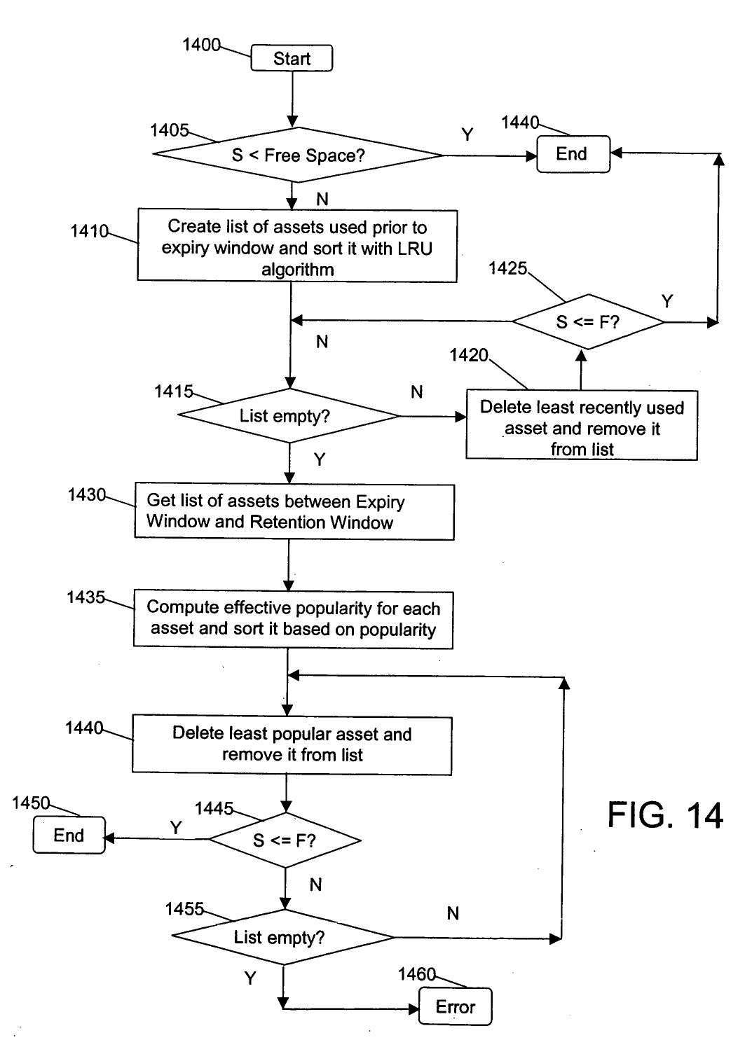

For a replication to be attempted, the conditions illustrated in step 1305 must be satisfied. There should also be space available for storing the replica of the content asset in the cache storage of the destination server. Cache storage may be in the form of a cache storage device such as in the VoD systems shown in FIGS. 4A-B or in the form of a disk cache in a cache server such as in the VoD systems shown in FIGS. 7 and 8. In case there is no space available in the cache storage of the destination server, cache space is reclaimed according to the cache reclamation algorithm described hereinbelow with reference to FIG. 14 (step 1310).

If cache reclamation or the replication itself fails due to some other reason (step 1315), for example, if there is no bandwidth available for the replication, the replication is then rescheduled for a future time, provided that retries are still available and that the end time has not elapsed (step 1320). The new replication time is then computed by dividing the interval between the replication start time and the replication end time into smaller sub-windows, attempting to replicate immediately as soon as an opportunity becomes available. Retry time for subsequent attempts within a sub-window is computed using exponential back off. When each sub-window elapses, the retry time is reset for immediate consideration and the replication parameters are updated (step 1330).

III. Exemplary Cache Reclamation Algorithm

Referring now to FIG. 14, a flow chart illustrating exemplary steps performed by the cache reclamation algorithm for reclaiming cache storage space according to an embodiment of the present invention is described. The cache reclamation algorithm reclaims cache storage space based on the popularity of the content assets in the cache storage to be reclaimed.

Asset popularity is computed for assets within a time window to guarantee that assets are not reclaimed right after being ingested into the VoD system or that popular assets are not immediately reclaimed. Content assets that were used prior to an “expiry window,” i.e., content assets that were used prior to a predetermined time window beyond which assets are not considered to be active, are all candidates for removal from the cache storage. The expiry window may be, for example, one week or more. Assets used prior to the expiry window are sorted according to their use using a least-recently used (“LRU”) sorting order (step 1410). The content assets in the list are then deleted until the required reclamation space is created or all the assets in the list have been deleted (steps 1415-1425).

When the list of assets used prior to the expiry window has been emptied (step 1415), a list of content assets that are still remaining in the cache storage between a “retention window” and the “expiry window” is created (step 1430). The retention window is a time window in which content assets within the window are under observation and not considered as candidates for removals. The retention window, typically 24 hours, is enforced to ensure that content assets placed into cache storage, be it the cache storage devices illustrated in FIGS. 4A-B or the disk cache of the cache servers illustrated in FIGS. 7-8, are not selected for reclamation right away.

Asset popularity is then computed for all the content assets in the list, which is sorted according to asset popularity (step 1435). Asset popularity for a given content asset may be computed based on the number of times the content asset was used and the last time when it was used, as follows:
Popularity=Retention Weight×Active Usage Count
where “Active Usage Count” denotes the number of times the content asset was used, and “Retention Weight” is a timing weight computed as:
Retention Weight=(Current Time−Last Use Time−Retention Window)/(Expiry Window−Retention Window)

The content assets in the list may then be sorted according to their asset popularity and the least popular assets are deleted from the cache until the required reclamation space is created or all the assets in the list are deleted (steps 1435-1455).

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

1. A system architecture for streaming content assets, the system architecture comprising:
a cluster of servers comprising a plurality of servers connected through a network for streaming content assets to a plurality of clients;
a plurality of storage devices connected to the plurality of servers, each storage device associated with one of the plurality of servers and comprising:
a first storage component for storing original content assets; and
a second storage component for storing replicas of the original content assets; and
a plurality of load balancing software modules running on the plurality of servers for load balancing storage and streaming requests among the plurality of servers in the cluster of servers.

2. The system architecture of claim 1, further comprising a load balancing component for connecting the cluster of servers to the plurality of clients.

3. The system architecture of claim 2, wherein the load balancing component comprises a plurality of load balancing software modules for load balancing storage and streaming requests among the plurality of servers in the cluster of servers.

4. The system architecture of claim 1, wherein the content assets comprise at least one of: audio assets, video assets, or time-based multimedia assets.

5. The system architecture of claim 1, wherein the content assets comprise fractions or prefixes of content assets.

6. The system architecture of claim 1, wherein the plurality of servers comprise ingest and streaming servers.

7. The system architecture of claim 1, further comprising a plurality of software agents running on the plurality of servers for sharing content asset metadata information among the plurality of servers and handling content asset requests made by one of the plurality of clients.

8. The system architecture of claim 7, wherein the content asset metadata information comprises information about the content asset comprising at least one of: content asset availability; content asset type; or content asset biographical information.

9. The system architecture of claim 7, wherein the plurality of software agents comprise software agents for selecting one server from the plurality of servers to store an incoming content asset based on resource availability and load balancing requirements.

10. The system architecture of claim 7, wherein the plurality of software agents comprise software agents for storing the incoming content asset in the second storage component of the selected server.

11. The system architecture of claim 7, wherein the plurality of software agents comprise software agents for selecting one server from the plurality of servers to service a streaming content request based on resource availability and load balancing requirements.

12. The system architecture of claim 11, wherein the plurality of software agents comprise software agents for determining whether the streaming content request exceeds the current streaming capacity of the cluster of servers.

13. The system architecture of claim 1, wherein the plurality of load balancing software modules comprise at least one of: a hot-asset replication software module; an aggressive caching software module; a load-based replication software module; or a time-based averaging software module.

14. The system architecture of claim 1, further comprising a replication software module for replicating content assets to the second storage component of one or more servers selected from the plurality of servers.

15. The system architecture of claim 1, further comprising a cache reclamation software module for reclaiming space in the second storage component of one or more servers selected from the plurality of servers to store replicas of the original content assets in the second storage component of the one or more servers.

16. A method for streaming content assets to a plurality of clients from a cluster of servers comprising a plurality of servers connected through a network, the method comprising:
storing a content asset in a first storage device associated with a first server from the plurality of servers based on the capacity of each one of the plurality of servers;
selecting a server from the plurality of servers to service a request for the content asset made by one of the plurality of clients;
making a replica of the content asset in a second storage device associated with a second server from the plurality of servers if future requests for the content asset will exceed the current capacity of the plurality of servers; and
load balancing subsequent requests for content assets among the plurality of servers.

17. The method of claim 16, wherein storing a content asset comprises storing at least one of: audio assets, video assets, or time-based multimedia assets.

18. The method of claim 16, wherein storing a content asset comprises storing fractions or prefixes of content assets.

19. The method of claim 16, wherein storing a content asset in a first storage device associated with a first server from the plurality of servers comprises storing the content asset in a title storage device.

20. The method of claim 16, wherein making a replica of the content asset in a second storage device associated with a second server from the plurality of servers comprises storing the content asset in a cache storage device associated with the second server.

21. The method of claim 16, wherein load balancing subsequent requests for content assets among the plurality of servers comprises replicating content assets based on resource availability and load balancing requirements using at least one of: a hot-asset replication software module; an aggressive caching software module; a load-based replication software module; or a time-based averaging software module.

22. The method of claim 16, further comprising reclaiming space in the second storage device of the second server to store the replica of the content asset.

23. A system architecture for streaming content assets to a plurality of clients, the system architecture comprising:
a cluster of servers comprising a plurality of library servers and a plurality of cache servers for streaming content assets to a plurality of clients;
a library storage device connected to the plurality of library servers for storing content assets;
a plurality of cache storage devices connected to the plurality of cache servers for storing content assets, each cache storage device associated with one of the plurality of cache servers; and
a plurality of load balancing software modules running on the plurality of library servers and on the plurality of cache servers for load balancing storage and streaming requests to the cluster of servers from the plurality of clients.

24. The system architecture of claim 23, wherein the library storage device comprises at least one of: a shared storage device; a plurality of library storage devices, each library storage device associated with one of the plurality of library servers; or a combination of a shared storage device and a plurality of library storage devices, each library storage device associated with one of the plurality of library servers.

25. The system architecture of claim 23, further comprising a load balancing component for connecting the cluster of servers to the plurality of clients.

26. The system architecture of claim 25, wherein the load balancing component comprises a plurality of load balancing software modules for load balancing storage and streaming requests among the plurality of library servers and the plurality of cache servers in the cluster of servers.

27. The system architecture of claim 23, wherein the content assets comprise at least one of: audio assets, video assets, or time-based multimedia assets.

28. The system architecture of claim 23, wherein the content assets comprise fractions or prefixes of content assets.

29. The system architecture of claim 23, wherein the plurality of library servers comprise ingest and streaming servers.

30. The system architecture of claim 23, wherein the content asset metadata information comprises information about the content asset comprising at least one of: content asset availability; content asset type; or content asset biographical information.

31. The system architecture of claim 23, further comprising a plurality of library software agents running on the plurality of library servers for sharing content asset metadata information among the plurality of library servers and the plurality of cache servers and handling content asset requests made by one of the plurality of clients.

32. The system architecture of claim 23, further comprising a plurality of cache software agents running on the plurality of cache servers for sharing content asset metadata information among the plurality of cache servers and handling content asset requests made by one of the plurality of clients.

33. The system architecture of claim 31, wherein the plurality of library software agents comprise software agents for selecting one library server from the plurality of library servers to store an incoming content asset based on resource availability and load balancing requirements in the library storage device associated with the selected library server.

34. The system architecture of claim 31, wherein the plurality of library software agents comprise software agents for streaming content assets stored in the library storage devices associated with the plurality of library servers directly to the plurality of clients.

35. The system architecture of claim 31, wherein the plurality of library software agents comprise software agents for replicating content assets stored in the library storage devices associated with the plurality of library servers to one or more of cache storage devices from the plurality of cache storage devices associated with the plurality of cache servers based on resource availability and load balancing requirements.

36. The system architecture of claim 32, wherein the plurality of cache software agents comprise software agents for streaming content assets stored in the cache storage devices associated with the plurality of cache servers directly to the plurality of clients.

37. The system architecture of claim 23, wherein the plurality of load balancing software modules comprise at least one of: a hot-asset replication software module; an aggressive caching software module; a load-based replication software module; or a time-based averaging software module.

38. The system architecture of claim 23, further comprising a replication software module for replicating content assets stored in the plurality of library storage devices to one or more cache storage devices from the plurality of cache storage devices.

39. The system architecture of claim 23, further comprising a cache reclamation software module for reclaiming space in one or more cache storage devices from the plurality of cache storage devices to store one or more replicas of a content asset stored in a library storage device.
